(19) United States
(12) Patent Application Publication
(10) Pub. No.: US 2014/0003711 A1
(43) Pub. Date: Jan. 2, 2014

(54) FOREGROUND EXTRACTION AND DEPTH INITIALIZATION FOR MULTI-VIEW BASELINE IMAGES

(71) Applicants: King Ngi Ngan, Shatin (HK); Chunhui Cui, Fanling (HK); Qian Zhang, Beijing (CN); Songnan Li, Shen Zhen (CN)

(72) Inventors: King Ngi Ngan, Shatin (HK); Chunhui Cui, Fanling (HK); Qian Zhang, Beijing (CN); Songnan Li, Shen Zhen (CN)

(73) Assignee: Hong Kong Applied Science and Technology Research Institute Co. Ltd., Shatin (CN)

(21) Appl. No.: 13/539,046

(22) Filed: Jun. 29, 2012

(51) Int. Cl. G06K 9/34

(52) U.S. Cl. 382/164

(57) ABSTRACT

Subject matter disclosed herein relates to foreground image extraction and image depth of video images.

### BACKGROUND

1. Field

Subject matter disclosed herein relates to foreground image extraction and image depth of video images.

2. Information

Three-dimensional television (3DTV) or Free Viewpoint TV (FTV) may allow a user to rotate a camera view (e.g., perspective) of an image to any of a number of angles or locations. For example, an image may be viewed as though a camera captured the image from a particular angle. The image may also be viewed as though the camera captured the image from another angle. Often an image includes a background and a featured object in the image foreground. For example, an image may include a person posing in a foreground. It may be desirable to extract such a foreground object from an image, leaving behind a background and other remaining portions of the image. Once isolated from the rest of an image, a foreground object may be viewed as though a camera captured the image of the object from any of a number of angles.

### BRIEF DESCRIPTION OF THE FIGURES

Non-limiting or non-exhaustive embodiments will be described with reference to the following figures, wherein like reference numerals refer to like parts throughout various figures unless otherwise specified.

FIGS. 1 and 2 show an image of a foreground object and a background at two different angles, according to an embodiment;

FIG. 3 shows a schematic representation of an image of a foreground object captured by any of a number of cameras, according to an embodiment;

FIG. 4 is a block diagram of an embodiment of a process to extract a foreground object from an image and to generate a depth map of an extracted foreground object;

FIG. 5 shows part of a process of matching features of a first image with features of a second image, according to an embodiment;

FIG. 6 is a flow diagram of an embodiment of a process to extract a foreground object from an image;

FIG. 7 shows images during a process of extracting a foreground object from the images;

FIG. 8 is a block diagram of an embodiment of a process to generate a depth map of an extracted foreground object; and

FIG. 9 is a schematic of an embodiment of a computing system.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, appearances of phrases such as “in one embodiment” or “an embodiment” in various places throughout this specification are not necessarily all referring to the same embodiment. Furthermore, particular features, structures, or characteristics may be combined in one or more embodiments.

In an embodiment, a process for electronically rotating a perspective view of an image, or an object of such an image, for example, may involve techniques for extracting the object from the image and generating electronic signals representing information describing a depth map for the object. For example, rotating a perspective view of an image may be useful for applications involving, among a number of other possibilities, three-dimensional television (3DTV) or Free Viewpoint TV (FTV), for example.

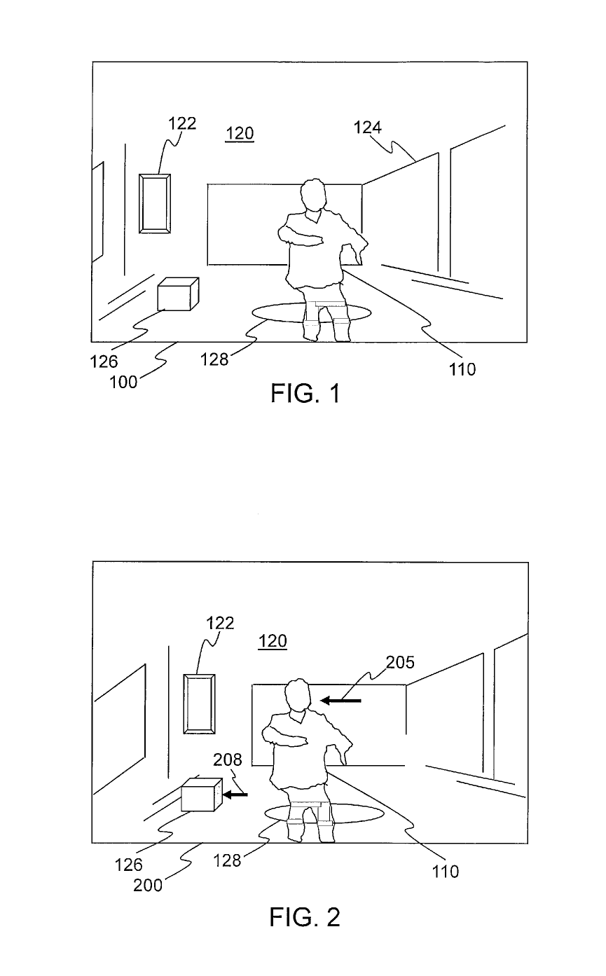

FIG. 1 shows an image 100 of a foreground object 110 and a background at a particular angle, according to an embodiment. For example, foreground object 110 may comprise an image of a person, while the background may include an image of a room and its contents, such as a painting 122 on wall 120, a window edge 124, furniture 126, and a rug 128, just to name a few examples. Of course, a foreground object and background contents may comprise any of a number of things, and claimed subject matter is not limited in this respect. Also, though examples describe processes or techniques to extract a foreground object from an image, it may be desirable to extract an object other than one in a foreground of an image. For example, an image of furniture 126 may be extracted from image 100. Accordingly, claimed subject matter is not limited to merely involving extracting a foreground object from an image, but other images “closer” to a background may also be involved.

FIG. 2 shows an image 200 of foreground object 110 and a background at a particular angle different from that of FIG. 1, according to an embodiment. For example, a position of a camera that captured image 200 may have been located one or a few meters from the position of the camera as it captured image 100. Accordingly, a perspective of foreground object 110 and background contents may shift relative to one another from image 100 to image 200. Further, such a shift in perspective may be different for different foreground objects and for different background contents depending, at least in part, on an image depth of the different foreground objects and background contents. Here, image depth, hereinafter, “depth”, of an object in an image refers to a spatial distance between the camera center and the object in the direction of the optical axis at the time the camera captured the image. Accordingly, a background object has a greater depth than a foreground object. In FIG. 1, for example, painting 122 on wall 120 may have a greater depth than furniture 126, which may have a greater depth than foreground object 110.

As just mentioned, a shift in perspective of objects in an image may be different for different objects depending, at least in part, on an image depth of the different objects. In particular, the greater the depth of an object, the lesser the shift in perspective of the object as camera position changes. For example, arrow 205 (e.g., a displacement vector) in FIG. 2 indicates an approximate shift in a position of foreground object 110 with respect to a background. Arrow 208 indicates an approximate shift in a position of furniture 126 with respect to the background. Because furniture 126 has a greater depth than that of foreground object 110, the shift of position of furniture 126 is less than that of foreground object 110, as indicated by the relative lengths of arrows 205 and 208.

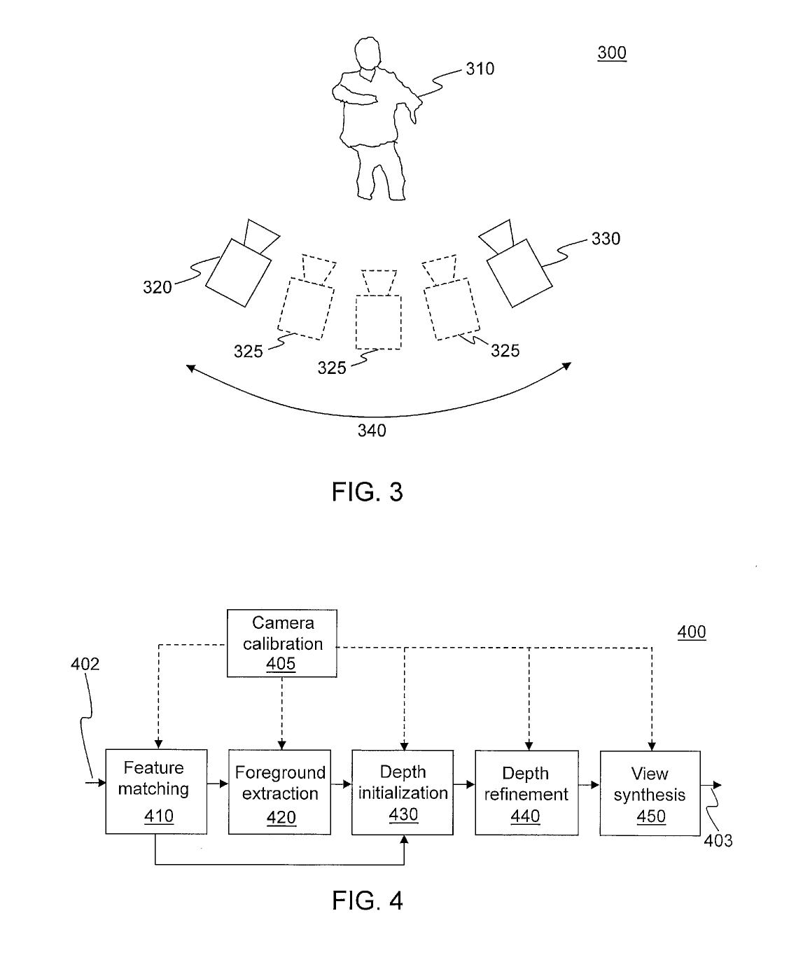

FIG. 3 shows a schematic representation of an image of a foreground object 310 captured by any of a number of camera positions 320, 330, or 325. In one embodiment, an image of object 310 may be captured by one camera at different locations at different times. In another embodiment, an image of object 310 may be captured by multiple cameras at different locations at same or different times. Accordingly, depending on context, identifiers “320”, “325”, or “330” may represent either different cameras or the same camera at different positions. Such a distinction will be made clear in discussions below. Returning to FIGS. 1 and 2, for example, image 100 may have been captured by camera 320 while image 200 may have been captured by camera 330.

In a particular embodiment, images 100 and 200 may be used in a process involving view synthesis. For example, image 100 may comprise a frame of a first video sequence captured by a first camera 320 while image 200 may comprise a frame of a second video sequence captured by a second camera 330. First and second cameras may comprise wide baseline video cameras. “Wide baseline” means that the distance between the two cameras is relatively large. As described below, a process involving view synthesis may be used to extract a foreground object, such as 310, from the video sequences, for example. In an implementation, view synthesis may generate arbitrary middle views of a foreground object. For example, cameras 325 may indicate various positions to capture a middle view of object 310 with respect to cameras 320 and 330. However, using view synthesis, camera 325 need not capture an image of object 310. Instead, first and second cameras 320 and 330 may be sufficient to allow for view synthesis from any perspective of object 310 in an angular range 340, for example. Accordingly, such view synthesis may be used for 3DTV or FTV, among any of a number of other applications.

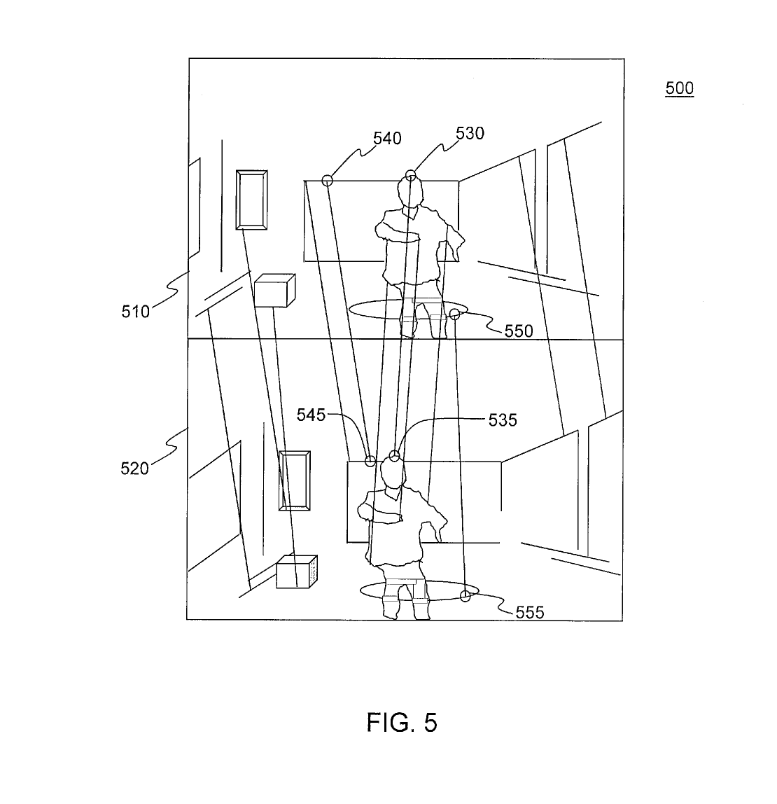

FIG. 4 is a block diagram summary of an embodiment of a process 400 to extract a foreground object from an image and to generate a depth map of an extracted foreground object. Here, a depth map may comprise an image whose pixel values represent depth values for each pixel in the image. Process 400 is merely a summary and details of each block are described below. For example, process 400 may comprise view synthesis introduced above. Process 400 may begin at block 410 by receiving two wide-baseline video sequences. At block 410, feature matching may be performed as shown, for example, in FIG. 5, which shows part of a process of matching features of a first image 510 with features of a second image 520. Lines are drawn between corresponding features in the two images, as explained below. Image 510 may be the same as example image 100 and image 520 may be the same as example image 200, for example. For example, image 510 may comprise a frame from a first video sequence captured by a first camera and image 520 may comprise a frame from a second video sequence captured by a second camera. A feature of an image may comprise one or more pixels of any portion of the image. For example, feature 540 in image 510 may comprise a particular portion of a window edge in the background of image 510. As another example, feature 550 in image 510 may comprise a particular portion of a rug. As yet another example, feature 530 may comprise a particular portion of a person, which may comprise a foreground object. Feature matching between two images may comprise a process of matching a feature of one image to a corresponding feature of the other image. For example, feature 545 in image 520 may comprise a corresponding feature to feature 540 in image 510. Similarly, feature 555 in image 520 may comprise a corresponding feature to feature 550 in image 510. Also, feature 535 in image 520 may comprise a corresponding feature to feature 530 in image 510. A number of other examples of corresponding (e.g., matched) features are shown in FIG. 5, indicated by lines connected the corresponding features. In a particular implementation of feature matching, hundreds or thousands of corresponding features between two images may be matched to one another.

At block 420, matched features from block 410 may be used in a process to extract a foreground object from images 510 and 520. In particular, matched features from block 410 may be used to segment a foreground object from an image background in a process described below. At block 430, a depth initialization process, also described below, may use matched features from block 410. For example, such matched features may be used to calculate an initial depth map for a foreground object. At block 440, such an initial depth map may be refined. At block 450, as described below, the refined depth map may be used for view synthesis. Finally, output 403 may comprise a synthesized middle view of a foreground object, such as that of foreground object 310 “captured” by camera 325, shown in FIG. 3.

In an embodiment, a process to extract a foreground object from an image may involve saliency map generation based, at least in part, on feature matching among two or more images, as explained below. Here, a “saliency map” may comprise an image whose pixel values represent saliency values for each pixel in the image. Matched features may subsequently be mapped into a set of feature points. Depth indicators for such feature points may be calculated using calibration parameters for the cameras that captured the images, such as at block 405 of process 400, for example. Saliency for such feature points may depend, at least in part, on a depth value of the individual feature points. Here, “saliency” refers to a region of interest. As a viewer views of an image, for example, the viewer most likely will notice a “saliency” region first. In an implementation, a saliency region may comprise a moving foreground object rather than a static or background region, for example. I If the depth of a feature point is relatively small, it is more likely that the feature point is from the foreground of an image. Accordingly, the feature point may be assigned with a relatively high saliency value. Such saliency values may be given by the following empirical function:

Sₐ(fᵢ)=exp{−γ[D(fᵢ)−Dₘᵢₙ]/[Dₘₐₓ−Dₘᵢₙ]} Equation (1)

This equation may comprise an expression for saliency Sₐ of a feature point fᵢ, which may be generated by matching features between two stereo images (e.g., two images from two video sequences). As mentioned above, depth of the feature point D(fᵢ) may be determined using calibration information for the cameras that captured the images, for example. The variable “γ” may comprise a control parameter which may be empirically fixed in a particular implementation. Dₘₐₓ and Dₘᵢₙ may represent maximum and minimum depths of a defined “reasonable depth range”. Here, “reasonable depth range”, indicated by [Dₘᵢₙ, Dₘₐₓ], is defined for video images such that there is no possibility that an object in the video is less than a defined minimum distance and more than a defined maximum distance (from the camera that captured the video). In a particular implementation, for example, such a minimum distance may be defined to be 1.0 centimeter and such a maximum distance may be defined to be 50.0 meters for a video captured in a relatively small room. Thus, Dₘᵢₙ=1 cm and Dₘₐₓ=50 m. In another implementation, Dₘₐₓ and Dₘᵢₙ may be determined by a depth range of interest. For example, a user may not be interested in objects that 100.0 meters or more away from the camera. Thus, Dₘₐₓ=100.0 meters. Feature points having depths out of the reasonable depth range may be removed.

After calculating a saliency value for feature points, pixel saliency Sₐ(pₖ) of a k^{th} pixel pₖ may be calculated using Equation (1). For individual feature points, a “support region” may be defined. Such a support region may comprise a local image patch having a feature point as its center, for example. For any pixel, if it is covered by a single feature, the saliency of the pixel may be set as the feature saliency. If the pixel is covered by multiple features, the saliency of the pixel may be set to a weighted average of the feature saliencies. If the pixel is not covered by any feature, the saliency of the pixel may be set to exp(−γ/2) since the depth of the pixel may be defined to be an average depth given by [Dₘₐₓ Dₘᵢₙ]/2. Here, “exp” means an exponential function.

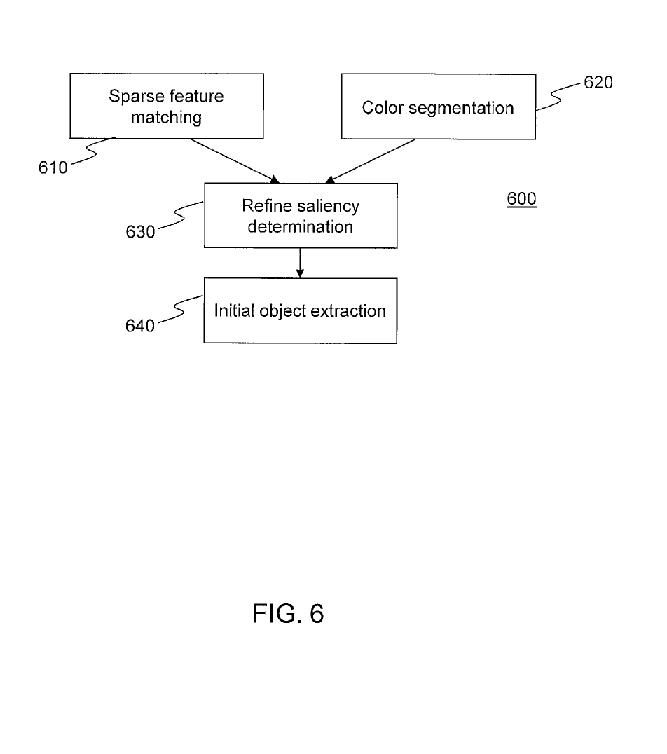

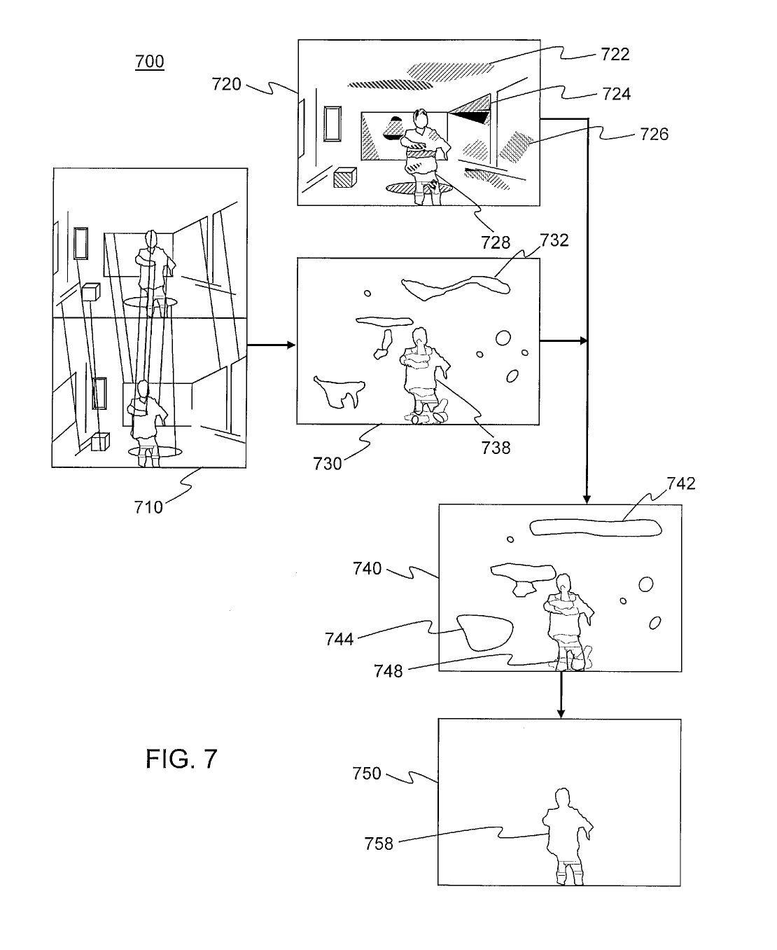

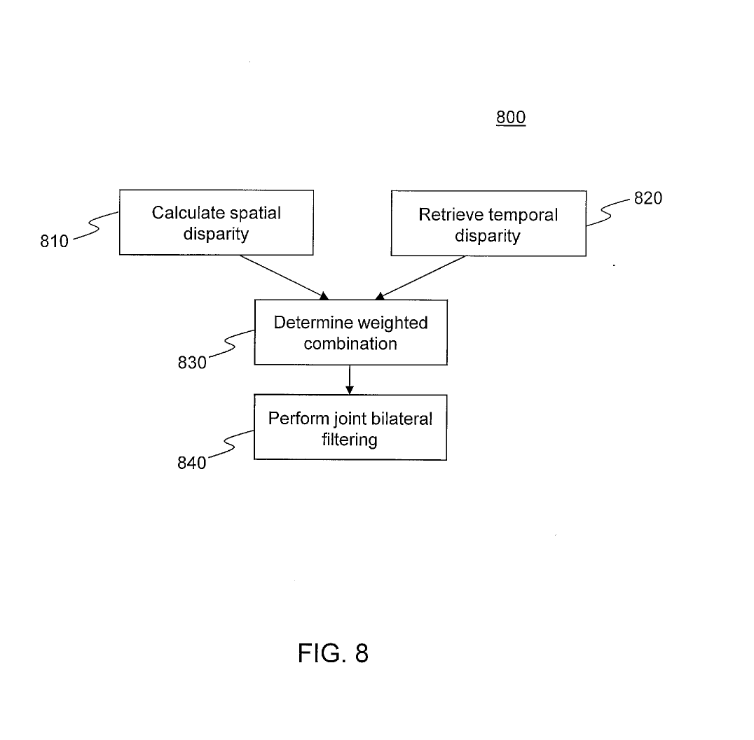

FIG. 6 is a flow diagram of an embodiment of a process 600 to extract a foreground object from an image. For example, process 600 may be used to extract foreground object 110 from image 100, shown in FIG. 1. FIG. 7 shows images during process 600 of extracting a foreground object from the images. At block 610, sparse feature matching may be performed as shown, for example, in image pair 710 in FIG. 7. Image pair 710 may be similar to images of embodiment 500, shown in FIG. 5, for example. Lines are drawn between corresponding features in the two images of 710. “Sparse” means that a number of matched feature points may be relatively few compared with a total pixel number. For example, for a 640×480 pixel-size image frame, the number of matched feature points may be one thousand or less (e.g., about 0.3% of the total number of pixels in the image frame). A process of matching features of the two images of 710 may generate sparse feature points. In other words, a sparse feature point may comprise a matched pair of features from two images. Depths of the feature points may be determined. As explained above, if a feature point depth is relatively small, it is likely that the associated feature is from a foreground of an image. Accordingly, a relatively high saliency value may be assigned to this feature. Such a feature saliency may then be propagated to other pixels in the image based, at least in part, on the features' support regions. Saliency map 730 shows an example outcome of such a propagation process. Different portions of saliency map 730 may have different saliency values. For example, object 738 may have a relatively high saliency while object 732 may have a relatively low saliency. Because feature points are sparse in this example, the saliency map 730 may be relatively poor and may not be sufficiently accurate to be used for foreground extraction.

Accordingly, color segmentation of block 620 may be used to refine saliency map 730. Color segmentation may comprise a type of quantization that may introduce robustness to process 600, for example. Such a segment-based quantization may, among other things, preserve sharp image boundaries, which may be desirable for accurate object extraction. Here, different portions of an image may be assigned saliency values based, at least in part, on the color of the different portions. Pixels within a segment Sᵢ may have the same saliency that may be defined to be an average of their original pixel saliencies, given by the following equation:

Sₐ(Sᵢ)=ΣSₐ(pₖ)/N_{Si} Equation (2)

Here, an average saliency Sₐ (Sᵢ) for a segment Sᵢ may be defined as a sum over all pixels in segment Sᵢ of individual pixel saliencies divided by the number of pixels in segment Sᵢ, for example.

Image 720 shows color segmentation of the top image of 710. Individual colors may represent a single segment, and pixels within the same segment may be assigned the same saliency value, which may be set as an average of the saliency values in an original saliency map. For example, portion 722 may comprise one segment of a particular color, and all pixels within the segment may be assigned the same saliency value. In another example, portion 724 may comprise one segment of another particular color, and all pixels within the segment may be assigned a saliency value that is the same for the pixels within the segment. For still another example, portion 726 may comprise one segment of yet another particular color, and all pixels within the segment may be assigned the same saliency value.

At block 630, color segmentation image 720 and saliency map 730 may be combined to generate a refined saliency map 740, which may be more accurate than saliency map 730. Different portions of saliency map 740 may have different saliency values. For example, object 748 may have a relatively high saliency while object 742 may have a relatively low saliency. By combining a color segmentation map 720 with an approximate saliency map 730, the saliency map 740 may be more accurate and be used for foreground extraction, as at block 640. Here, a foreground object 748 may be segmented from a background (e.g., 744 and 742) based, at least in part, on a threshold pixel saliency value. In other words, such a value may be selected so that portions of saliency map 740 having saliency values greater than the threshold value are extracted from the image. On the other hand, portions of saliency map 740 having saliency values less than the threshold value may be eliminated from the image. Image 750 includes an extracted foreground object 758. Of course, such details of process 600 are merely examples, and claimed subject matter is not so limited.

FIG. 8 is a block diagram of an embodiment of a process 800 to generate a depth map of an extracted foreground object. For example, such a process may be performed subsequent to extracting foreground object 110 from images 100 and 200. In this case, a depth map may be generated for extracted foreground object 110. In one implementation, after the extraction of a foreground object, its initial depth map may be calculated at block 430 of process 400, shown in FIG. 4, for example. Among other things, a depth map may be used for view synthesis at block 450. Process 800 may comprise a framework for initializing a depth map, as described in detail below. In one implementation, depth may be inferred from a spatial disparity. Here, “spatial disparity” refers to a pixel location disparity between a pixel in one frame and its corresponding (e.g., matching) pixel in another frame. For example, a particular pixel at location (x, y) in one frame may shift to a location (x+dₓ, y+d_{y}) in another frame. Accordingly, such a location shift may be indicated by an amount given by disparity d=(dₓ, d_{y}) of one frame relative to another frame, for example. The term “spatial disparity” is to be distinguished from “temporal disparity”, which has a different meaning, described below for an implementation. Accordingly, at block 810, such a spatial disparity may be calculated. For example, for an individual pixel at location (x, y) in an object region (e.g., a foreground object region), a feature point having a disparity d=(dₓ, d_{y}) may be determined so as to minimize a Score(x, y, sₓ, s_{y}). Here, (sₓ, s_{y}) indicates a location of a feature point. Accordingly, a pixel disparity may be set to an “optimal” related feature disparity (dₓ, d_{y}). Here, (dₓ, d_{y}) is defined as a disparity at a location (x, y). In one implementation, Score(x, y, sₓ, s_{y}) may be based, at least in part, on three terms: a spatial-distance term, a color-distance term, and a photo-consistency term. In particular, Score(x, y, sₓ, s_{y}) may be given by the following equation:

$$Score ( x , y , {s}_{x} , {s}_{y} ) = \{ ‖ x - {s}_{x} ‖ + ‖ y - {s}_{y} ‖ \} + \{ ‖ {I}_{1} ( x , y ) - {I}_{1} ( {s}_{x} , {s}_{y} ) ‖ \} + \{ ‖ {I}_{1} ( x , y ) - {I}_{2} ( x + {d}_{x} , y + {d}_{y} ) ‖ \} , \qquad Equation ( 3 )$$

wherein the first term comprises a spatial-distance term, the second term comprises a color-distance term, and the third term comprises a photo-consistency term, for example. Here, I₁(x, y) comprises a color luminance value at a location (x, y) for a first image and I₂(x+d_{X}, y+d_{y}) comprises a color luminance value at a location (x, y) offset by a distance given by disparity (dₓ, d_{y}) for a second image. The three terms in Equation (3) may be used to quantify how closely a feature point is related to a pixel. For example a spatial-distance term may quantify a spatial distance between a feature point and a pixel; a color-distance term may quantify a color difference between a feature point and a pixel; and a photo-consistency term may quantify a photo consistency of a pixel between images based on a feature disparity. Such a process of involving Score(x, y, sₓ, s_{y}) with a disparity determination may utilize invariant features, which may be relatively robust to viewpoint (e.g., perspective) changes between wide baseline images. Accordingly, such determined disparities may be relatively accurate.

At block 820, temporal disparity may be retrieved from a previous frame. In one implementation, a process of block 820 may include performing motion estimation. Then, for individual pixels xᵢ in a current video frame n, its corresponding pixel xᵢ′ in a previous frame (frame n−1) may be determined. A final disparity of xᵢ′ may comprise a temporal disparity of xᵢ. At block 830, values for spatial disparity and temporal disparity may be combined by a weighted average to improve a temporal consistency of a synthesis result, for example. In one embodiment of a weighted combination process, let d be the spatial disparity, and d′ be the temporal disparity. (Note that a combination process may use horizontal disparity dₓ but not need to use vertical disparity d_{y} since disparity d_{y} may be calculated directly given dₓ according to an “epi-polar” geometry constraint, for example). In such a case, d and d′ may be combined to produce the temporally smooth result:

$${d}_{f} = \frac{w \times d + {w}^{′} \times {d}^{′}}{w + {w}^{′}}$$

where w=S_{d′} and w=S_{d}. Here, in a particular implementation, S_{d} and S_{d′} are matching scores for d and d′, respectively. A relatively large matching score may indicate a relatively less accurate disparity result. In one implementation a matching score for a current pixel may be updated by using the following equation:

$${S}_{{d}_{f}} = \frac{w \times {S}_{d} + {w}^{′} \times {S}_{{d}^{′}}}{w + {w}^{′}}$$

Such a process of combining spatial and temporal disparities may allow for temporal consistency of depth from one frame to a next frame of a video, for example, which may be important for view synthesis. Such a process of combining spatial and temporal disparities may provide an advantage by exploiting feature matching results. For example, a pixel in a particular video frame image may be far from a feature point, and may have a relatively large matching score. But in a previous video frame, the corresponding pixel may be relatively close to a feature point, so a temporal disparity of the corresponding pixel may be more accurate than its spatial disparity. Accordingly, a weighting factor for the temporal disparity may be relatively large. In this way, feature matching results of a previous frame may be used to improve depth initialization in a current frame.

At block 840, adaptive joint bilateral filtering may be applied to smooth a disparity map. Here, “adaptive” refers to a process of changing a parameter of joint bilateral filtering according to a matching score, such as that given by Equation (3), for example. In one implementation, a joint bilateral filter may be formulated as:

$${D}^{′} ( p ) = \frac{1}{{W}_{p}} {\sum }_{q ∈ Q} {G}_{{δ}_{s}} ( ‖ q - p ‖ ) {G}_{{δ}_{c}} ( ‖ {c}_{q} - {c}_{p} ‖ ) D ( q )$$

where p is the current pixel, Q is a local region with p as its center, q indicates the pixel in Q, ∥q−p∥ indicates the spatial distance between p and q, ∥c_{q}−cₚ∥ indicates the color difference between q and p, and D′(p) is the disparity after performing the bilateral filtering process. The factor in front of the summation may comprise a normalization factor. G (∥q−p∥) may comprise a space weight factor, and G (∥q−p∥) may comprise a color weight factor, for example. G may comprise a Gaussian distribution while δ_{S} and δ_{C} may indicate space and color parameters, respectively. In an implementation, one of these two parameters, such as the space parameter, for example, may be changed adaptively in accordance with S_{d}_{_{f}}. For example, if S_{d}_{_{f}} is relatively small, it may indicate that the disparity d_{f} is relatively accurate. In this case, a relatively small δ_{S} (e.g., weaker filtering) may be applied. One example of mapping from S_{d}_{_{f}} to δ_{S} may be defined by a piecewise linear rule, as follows:

$$\{ \begin{matrix}{δ}_{s} = {δ}_{MAX} & if {S}_{{d}_{f}} > {S}_{MAX} \\ {δ}_{s} = ( {δ}_{MAX} - {δ}_{MIN} ) \frac{( {S}_{{d}_{f}} - {S}_{MIN} )}{( {S}_{MAX} - {S}_{MIN} )} + {δ}_{MIN} & if {S}_{MAX} \geq {S}_{{d}_{f}} \geq {S}_{MIN} \\ {δ}_{s} = {δ}_{MIN} & if {S}_{{d}_{f}} < {S}_{MIN}\end{matrix}$$

where the parameters may be set empirically, for example.

Such a process may provide an advantage by exploiting feature matching results. For example, if a matching score is relatively small, a pixel in a particular video frame image may be more likely to benefit from nearby feature points. If using a high filtering intensity, disparity may become less accurate. Therefore, adaptively changing a filtering intensity according to a matching score may allow use of feature matching results. Of course, such details of embodiment 800 are merely examples, and claimed subject matter is not so limited.

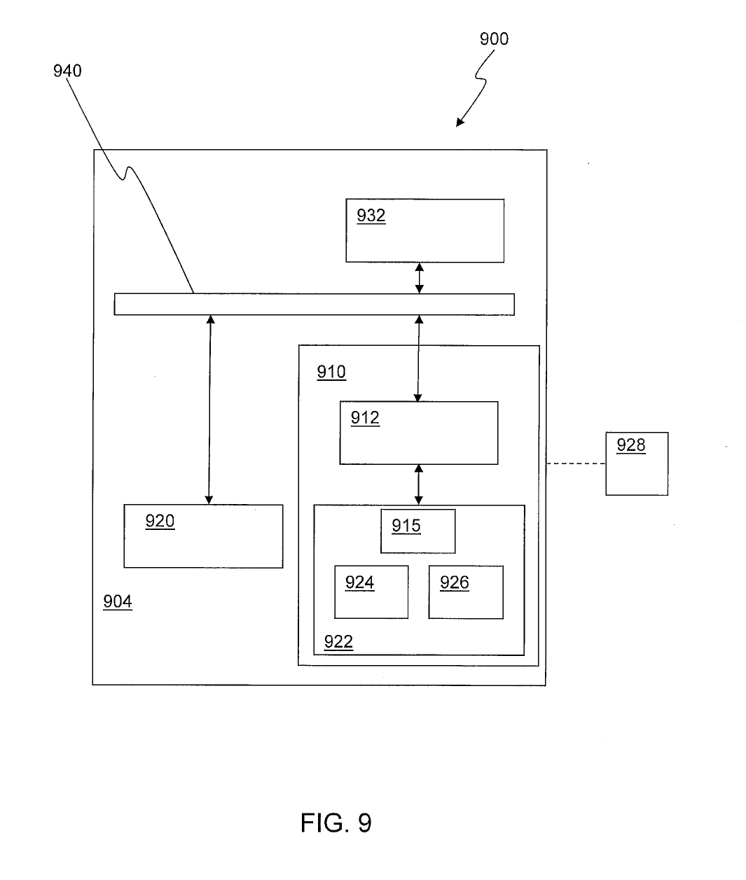

FIG. 9 is a schematic diagram illustrating an embodiment of a computing system 900. A computing device may comprise one or more processors, for example, to execute an application or other code. For example, among other things, an application may perform processes 400, 600, or 800 described above. In a particular implementation, computing system 900 may perform a process of extracting a foreground object from an image, and generating a depth map for such an extracted object, for example.

A computing device 904 may be representative of any device, appliance, or machine that may be employed to manage memory device 910. Memory device 910 may include a memory controller 915 and a memory 922. By way of example, but not limitation, computing device 904 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or information storage service provider or system; or any combination thereof.

All or part of various devices, such as shown in system 900, or processes and methods such as described herein, for example, may be implemented using or otherwise including hardware, firmware, software, or any combination thereof (although this is not intended to refer to software per se). Thus, by way of example, but not limitation, computing device 904 may include at least one processing unit 920 that is operatively coupled to memory 922 via a bus 940 and memory controller 915. Processing unit 920 may be representative of one or more circuits to perform at least a portion of a computing procedure or process. For example, a process to generate a depth map for a foreground object extracted from an image may comprise associating individual pixels with a feature point that is at least partially invariant to viewpoint changes between a first image and a second image of a video; determining a spatial disparity between the individual pixels and the feature point based, at least in part, on a matching function; determining a temporal disparity between the individual pixel of the first image and the individual pixel of a previous image; and calculating a value for the depth of the individual pixel based, at least in part, on the spatial disparity and the temporal disparity.

By way of example but not limitation, processing unit 920 may include one or more processors, controllers, microprocessors, microcontrollers, application specific integrated circuits, digital signal processors, programmable logic devices, field programmable gate arrays, the like, or any combination thereof. Processing unit 920 may include an operating system to communicate with memory controller 915. An operating system may, for example, generate commands to be sent to memory controller 915 over or via bus 940. Commands may comprise read or write commands, for example.

Memory 922 may be representative of any information storage mechanism. Memory 922 may include, for example, a primary memory 924 or a secondary memory 926. Primary memory 924 may include, for example, a random access memory, read only memory, etc. While illustrated in this example as being separate from processing unit 920, it should be understood that all or part of primary memory 924 may be provided within or otherwise co-located/coupled with processing unit 920.

Secondary memory 926 may include, for example, the same or similar type of memory as primary memory or one or more information storage devices or systems, such as, for example, a disk drive, an optical disc drive, a tape drive, a solid state memory drive, etc. In certain implementations, secondary memory 926 may be operatively receptive of, or otherwise able to couple to, a computer-readable medium 928. Computer-readable medium 928 may include, for example, any medium able to carry or make accessible signal or state information, code, or instructions for one or more devices, such as in system 900. Computing device 904 may include, for example, an input/output 932.

Input/output 932 may be representative of one or more devices or features able to accept or otherwise introduce human or machine produced signal inputs, or one or more devices or features able to deliver or provide human or machine comprehendible signal outputs. By way of example but not limitation, input/output device 932 may include a display, speaker, keyboard, mouse, trackball, touch screen, signal port, etc.

It will, of course, be understood that, although particular embodiments have just been described, claimed subject matter is not limited in scope to a particular embodiment or implementation. For example, one embodiment may be in hardware, such as implemented on a device or combination of devices, for example. Likewise, although claimed subject matter is not limited in scope in this respect, one embodiment may comprise one or more articles, such as a storage medium or storage media that may have stored thereon instructions capable of being executed by a specific or special purpose system or apparatus, for example, to result in performance of an embodiment of a method in accordance with claimed subject matter, such as one of the embodiments previously described, for example. However, claimed subject matter is, of course, not limited to one of the embodiments described necessarily. Furthermore, a specific or special purpose computing platform may include one or more processing units or processors, one or more input/output devices, such as a display, a keyboard or a mouse, or one or more memories, such as static random access memory, dynamic random access memory, flash memory, or a hard drive, although, again, claimed subject matter is not limited in scope to this example.

In some circumstances, operation of a processor or a memory device, such as a change in state from a binary one to a binary zero or vice-versa, for example, may comprise a transformation, such as a physical transformation. For example, electronic signals, which may be transformed from one state to another, may be used to represent features described in embodiments. For example, a process for extracting a foreground object from an image and to generate a depth map of an extracted foreground object may comprise one or more transformations of electronic signals from one state to another during such a process. For example, a matching function used to determine spatial disparity in process 800 may involve one or more transformations of electronic signals from one state to another by a special purpose computer executing code comprising electronic signals.

With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list of all examples in which a change in state for a binary one to a binary zero or vice-versa in a memory device may comprise a transformation, such as a physical transformation. Rather, the foregoing are intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

Methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, “applying,” and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

In the preceding description, various aspects of claimed subject matter have been described. For purposes of explanation, specific numbers, systems, or configurations may have been set forth to provide a thorough understanding of claimed subject matter. However, it should be apparent to one skilled in the art having the benefit of this disclosure that claimed subject matter may be practiced without those specific details. In other instances, features that would be understood by one of ordinary skill were omitted or simplified so as not to obscure claimed subject matter. While certain features have been illustrated or described herein, many modifications, substitutions, changes, or equivalents may now occur to those skilled in the art. It is, therefore, to be understood that the appended claims are intended to cover all such modifications or changes as fall within the true spirit of claimed subject matter.

What is claimed is:

1. A method for extracting one or more foreground objects from multiple images, the method comprising:
matching features in a first image with corresponding features in a second image;
determining image depths of at least a portion of the matched features;
determining saliency of said matched features based, at least in part, on said image depths; and
refining said saliency of said matched features based, at least in part, on color segmentation of said first or second image.

2. The method of claim 1, further comprising:
segmenting said one or more foreground objects from a background based, at least in part, on a threshold pixel saliency value.

3. The method of claim 1, wherein said saliency of said matched features is based, at least in part, on an exponential function of said image depths.

4. The method of claim 3, wherein said image depths are based, at least in part, on spatial disparities of said matched features.

5. The method of claim 2, and further comprising:
setting at least a portion of pixels within a particular color segment to a same pixel saliency.

6. The method of claim 1, wherein said saliency of said matched features increases for decreasing said image depths.

7. The method of claim 1, wherein said first and second images comprise a frame of a first video sequence and a second video sequence, respectively.

8. A method for generating a depth map of an object from video images, the method comprising:
for individual pixels of said object,
associating said individual pixel with a feature point that is at least partially invariant to viewpoint changes between said image and a second image of said video;
determining a spatial disparity between said individual pixel and said feature point based, at least in part, on a matching function;
determining a temporal disparity between said individual pixel of said image and said individual pixel of a previous image; and
calculating a value for the depth of said individual pixel based, at least in part, on said spatial disparity and said temporal disparity.

9. The method of claim 8, further comprising:
modifying said value for said depth of said individual pixel using adaptive joint bilateral filtering based, at least in part, on a weighted combination of said spatial disparity and said temporal disparity; and
for a plurality of said pixels, arranging the modified values for said depths of said pixels to generate said depth map.

10. The method of claim 8, wherein said matching function comprises:
a first term based, at least in part, on a spatial distance between said individual pixel and said feature point; and
a second term based, at least in part, on color distance between said individual pixel and said feature point.

11. The method of claim 10, wherein said matching function further comprises a third term based, at least in part, on photo-consistency of said individual pixel between said image and said previous image.

12. The method of claim 8, wherein said determining said spatial disparity comprises:
selecting a disparity pixel of said object that minimizes said matching function for said individual pixel.

13. The method of claim 8, wherein said calculating said value for said depth of said individual pixel further comprises combining said spatial disparity and said temporal disparity using a weighting factor based, at least in part, on said matching function.

14. The method of claim 9, wherein said weighted combination of said spatial disparity and said temporal disparity is weighted based, at least in part, on said matching function.

15. An apparatus comprising:
one or more cameras; and
a special purpose computing system, said special purpose computing system to:
for individual pixels of an object of an image of a video,
associate said individual pixel with a feature point that is at least partially invariant to viewpoint changes between said image and a second image of said video;
determine a spatial disparity between said individual pixel and said feature point based, at least in part, on a matching function;
determine a temporal disparity between said individual pixel of said image and said individual pixel of a previous image; and
calculate a value for the depth of said individual pixel based, at least in part, on said spatial disparity and said temporal disparity.

16. The apparatus of claim 15, said special purpose computing system further to:
modify said value for said depth of said individual pixel using adaptive joint bilateral filtering based, at least in part, on a weighted combination of said spatial disparity and said temporal disparity; and
for a plurality of said pixels, arrange the modified values for said depths of said pixels to generate said depth map.

17. The apparatus of claim 15, wherein said matching function comprises:
a first term based, at least in part, on a spatial distance between said individual pixel and said feature point; and
a second term based, at least in part, on color distance between said individual pixel and said feature point.

18. The apparatus of claim 17, wherein said matching function further comprises a third term based, at least in part, on photo-consistency of said individual pixel between said image and said previous image.

19. The apparatus of claim 15, wherein said calculating said value for said depth of said individual pixel further comprises combining said spatial disparity and said temporal disparity using a weighting factor based, at least in part, on said matching function.

20. The apparatus of claim 16, wherein said weighted combination of said spatial disparity and said temporal disparity is weighted based, at least in part, on said matching function.
